(19) United States
(12) Patent Application Publication
(10) Pub. No.: US 2013/0260233 A1
(43) Pub. Date: Oct. 3, 2013

(54) LITHIUM BATTERY ANODE HAVING PROTECTIVE FILM MADE UP OF INORGANIC PARTICLES AND LITHIUM BATTERY

(71) Applicants: BOR-YUAN HSIAO, Tu-Cheng (TW); CHENG-CHUNG CHIU, Tu-Cheng (TW); CHIEN-FANG HUANG, Tu-Cheng (TW)

(72) Inventors: BOR-YUAN HSIAO, Tu-Cheng (TW); CHENG-CHUNG CHIU, Tu-Cheng (TW); CHIEN-FANG HUANG, Tu-Cheng (TW)

(73) Assignees: UER TECHNOLOGY CORPORATION, Miaoli County (TW); UER TECHNOLOGY (SHENZHEN) LIMITED, ShenZhen (CN)

(21) Appl. No.: 13/584,764

(22) Filed: Aug. 13, 2012

(30) Foreign Application Priority Data
Mar. 28, 2012 (TW) 101110706

(51) Int. Cl. H01M 4/64; H01M 4/66; B82Y 30/00

(52) U.S. Cl. 429/211; 977/755

(57) ABSTRACT

A longer-lasting lithium battery anode includes a current collector, an anode active material layer, and a protective film. The anode active material layer is coated on the current collector. The protective film is coated on the anode active material layer, and the protective film consists of inorganic particles.

### BACKGROUND

1. Technical Field

The present disclosure relates to lithium batteries and, particularly, to a lithium battery having steady capacity.

2. Description of Related Art

Lithium batteries are widely used in consumer electronic devices such as mobile phones and laptops. A lithium battery includes a cathode, an anode, an electrolyte, and an isolating film. The anode includes a current collector and an anode active material layer coated on the current collector. However, high temperatures may cause the anode active material to dissolve in the electrolyte, which reduces the capacity of the lithium battery.

Therefore, a lithium battery anode and a lithium battery which can overcome the above-mentioned problems are needed.

### BRIEF DESCRIPTION OF THE DRAWINGS

FIG. 1 is a schematic view of a lithium battery anode according to a first embodiment.

FIG. 2 is a schematic view of a lithium battery according to a second embodiment, the lithium battery including the lithium battery anode of FIG. 1.

FIG. 3 is a graph showing the results of charge-discharge testing on a known lithium battery and a lithium battery according to an embodiment.

### DETAILED DESCRIPTION

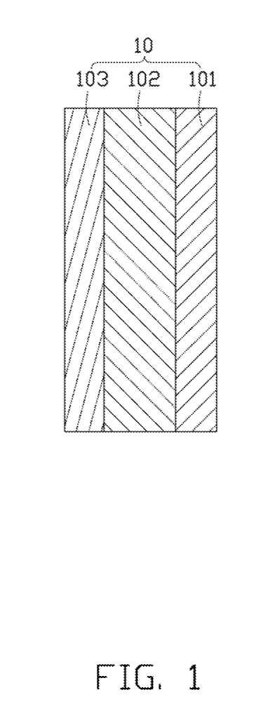

Referring to FIG. 1, a lithium battery anode 10 according to a first embodiment is shown. The lithium battery anode 10 includes a current collector 101, an anode active material layer 102, and a protective film 103. The current collector 101 is made of metal or carbon and has good electric conductivity. In this embodiment, the current collector 101 is made of aluminum foil. The anode active material layer 102 is made of composite oxides of lithium and transition metals. The composite oxides of lithium and transition metals may be lithium manganese oxide, lithium nickel oxide, lithium titanium oxide, lithium cobalt oxide, and so on, such as LiCoO₂, LiMn₂O₄, LiFePO₄, LiNiₓCo_{y}Mn_{z}O₂ (0<x, y, z<1), LiNiₓCo_{y}Al_{z}O₂ (0<x, y, z<1), LiNi_{0.5}Mn_{1.5}O₄, and Li₄Ti₅O₁₂. The anode active material layer 102 is coated on the current collector 101. The protective film 103 is made up of inorganic particles. The inorganic particles may have their origin in metal oxide, such as ZrO₂, Mg(OH)₂, MgO, TiO₂, Al₂O₃, La₂O₃, ZnO. The thickness of the protective film 103 is less than 100 nanometers.

The protective film 103 is coated on the cathode active material layer 102 by means of an evaporation or sputtering process. During coating, micropores are formed in the protective film 103 as the inorganic particles have irregular shapes. Lithium ions can pass through the micropores of the protective film 103.

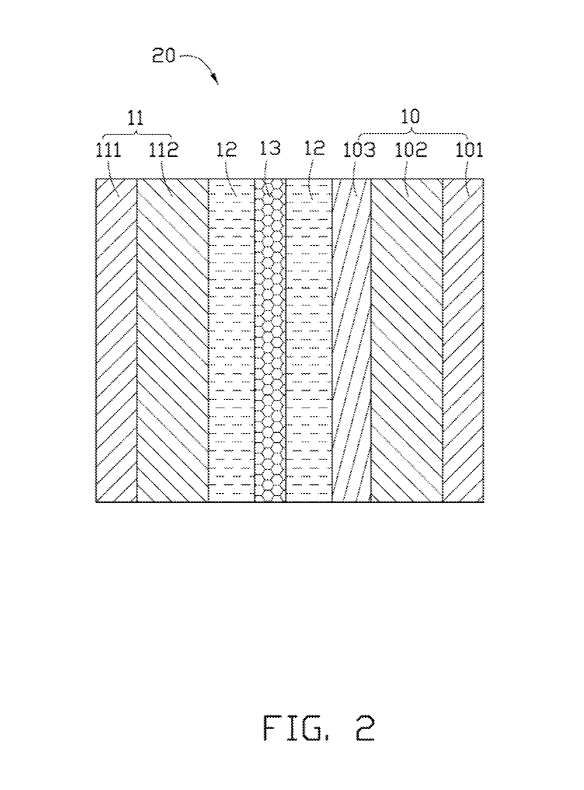

Referring to FIG. 2, a lithium battery 20 according to a second embodiment is shown. The lithium battery 20 includes a cathode 11, an electrolyte 12, an isolating film 13, and the anode 10 of the first embodiment.

The cathode 11 includes a current collector 111 and a cathode active material layer 112 coated on the current collector 111. The cathode active material layer 112 is made of carbon material, or transition metal, or a transition metal oxide, such as graphite, carbon fiber, carbon nanotubes, tin, and tin oxide. The electrolyte 12 is an organic electrolytic solution comprised of an organic solution containing lithium salt. The organic solution is propylene carbonate, glycol carbonate, dimethyl carbonate, or the like. The lithium salt is lithium perchlorate, lithium tetrafluoroborate, lithium hexafluorophosphate, or the like.

The isolating film 13 is made from non-woven inorganic paper, or from microporous polymeric membranes.

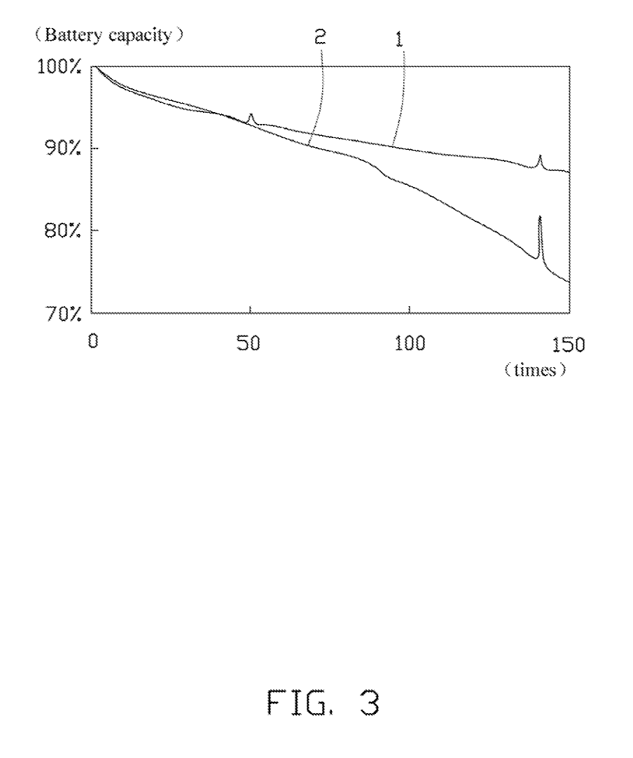

FIG. 3 shows the result of charge-discharge testing on lithium batteries using 4.4 volts. A curve 1 shows the result of the test on the lithium battery 20 having the protective film 103. A curve 2 shows the result of the test on a lithium battery without the protective film 103. FIG. 3 shows that after a number of charges and discharges, the capacity of the lithium battery 20 having the protective film 103 is higher than the capacity of the battery without the protective film 103. It is clear from FIG. 3 that the protective film 103 prevents the anode active material 102 from being dissolved in the electrolyte 12 and stabilizes the capacity of the lithium battery, thus significantly extending the life of the lithium battery 20.

It is to be understood, however, that even though numerous characteristics and advantages of the present embodiments have been set forth in the foregoing description, together with details of the structures and functions of the embodiments, the disclosure is illustrative only, and changes may be made in detail, especially in the matters of shape, size, and arrangement of parts within the principles of the disclosure to the full extent indicated by the broad general meaning of the terms in which the appended claims are expressed.

What is claimed is:

1. A lithium battery anode, comprising:
a current collector;
an anode active material layer coated on the current collector; and
a protective film coated on the anode active material layer, the protective film consisting of inorganic particles.

2. The lithium battery anode of claim 1, wherein the protective film is made of metal oxide.

3. The lithium battery anode of claim 2, wherein the protective film is made of at least one selected from the group consisting of ZrO₂, Mg(OH)₂, MgO, TiO₂, Al₂O₃, La₂O₃, and ZnO.

4. The lithium battery anode of claim 1, wherein a thickness of the protective film is less than 100 nano-meters.

5. The lithium battery anode of claim 1, wherein the anode active material layer is made of composite oxides of lithium and transition metals.

6. The lithium battery anode of claim 1, wherein the current collector is made of metal or carbon.

7. A lithium battery, comprising:
an cathode;
an electrolyte;
an isolating film; and
a anode comprising:
a current collector;
a anode active material layer coated on the current collector; and
a protective film coated on the anode active material layer, the protective film consisting of inorganic particles.

8. The lithium battery of claim 7, wherein the protective film is made of metal oxide.

9. The lithium battery of claim 8, wherein the protective film is made of at least one selected from the group consisting of ZrO₂, Mg(OH)₂, MgO, TiO₂, Al₂O₃, La₂O₃, and ZnO.

10. The lithium battery of claim 7, wherein a thickness of the protective film is less than 100 nano-meters.

11. The lithium battery of claim 7, wherein the anode active material layer is made of composite oxides of lithium and transition metals.

12. The lithium battery of claim 7, wherein the current collector is made of metal or carbon.
